(19) United States
(12) Patent Application Publication
(10) Pub. No.: US 2021/0243852 A1
(43) Pub. Date: Aug. 5, 2021

(54) Magnetic Induction Heating System, Dehydrator and Oxyhydrogen Generator for converting mechanical motion into chemical energy.

(71) Applicant: Elberto Berdut-Teruel, San Juan, PR (US)

(72) Inventor: Elberto Berdut-Teruel, San Juan, PR (US)

(21) Appl. No.: 17/161,782

(22) Filed: Jan. 29, 2021

Related U.S. Application Data
(60) Provisional application No. 62/969,882, filed on Feb. 4, 2020.

(51) Int. Cl. H05B 6/10; C01B 3/04; B01J 6/00; F26B 3/084; H01F 7/02

(52) U.S. Cl. CPC H05B 6/108; C01B 3/045; A23N 12/083; F26B 3/084; H01F 7/02; B01J 6/008

(57) ABSTRACT

A magnetic field thermal generator has one or more heat elements comprised of rotating pipes placed so they travel across the magnetic field generated by the magnetic field chamber, with said magnetic field being generated by either permanent magnets or electromagnets. The relative motion of the heat element to the magnetic flux from the magnetic field magnets results in heat generation, as well as in the generation of Oxyhydrogen (HHO). An optional hydrogen separator may be used to separate the HHO into the Hydrogen and Oxygen components.

### CROSS-REFERENCE TO RELATED APPLICATIONS

This application claims priority to co-pending U.S. Provisional patent applications Ser. No. 62/969,882 titled “Magnetic Induction Heating System, Dehydrator and Hydrogen Generator”, filed on Feb. 4, 2020, the disclosure of which is herein incorporated by reference in its entirety.

### PATENTS CITED

The following documents and references are incorporated by reference in their entirety, Berdut-Teruel (US Pat. Pub. No. 2011/0272398), Berdut-Teruel (U.S. Pat. Nos. 8,866,053 and 9,618,264), Kongmark et al (U.S. Pat. No. 7,935,254), Noda (European Patent Appl. EP2147897), Coffman (U.S. Pat. No. 5,036,602), Clawson (U.S. Pat. No. 4,665,628), Botkins et al (U.S. Pat. No. 4,263,722), Lee et al (2004/0050801), Skeist et al (U.S. Pat. No. 6,984,897), Gerard et al (U.S. Pat. No. 5,012,060) and Mohr (U.S. Pat. No. 4,671,527).

### FIELD OF THE INVENTION

The present invention generally relates to the gasification of moisture within a gas by the separation of the water molecules present in it into their separate hydrogen and oxygen components, and specifically to the gasification of humidity from material that is heated and subjected to a magnetic field generated via electromagnetic or permanent magnet mechanisms.

### DESCRIPTION OF THE RELATED ART

Many processes today use fossil fuels (either directly or through the use of electricity generated using said fossil fuels). For example, clothe driers, water heaters, space heaters and other applications such as these are routinely performed using thermic heat generated either via electric radiance, or through the burning of gases such as Propane.

The induction of heat via electric current created electromagnetic fields is well understood and has been selected by many designers in order to tightly control the application of the heat (via the intensity of the magnetic field). However, in many cases, permanent magnet thermal generators are not used. This results in the burning of additional resources in order to generate the heat for the process.

A number of permanent magnet thermal generators have been suggested in the past. Skeist et al (U.S. Pat. No. 6,984,897), Gerard et al (U.S. Pat. No. 5,012,060) and Mohr (U.S. Pat. No. 4,671,527), among others, suggest the use of permanent magnets and a heat transfer fluid.

Most of these produce the heat, but often at the cost of additional complexity. In most cases, these permanent magnet thermal generators have the undesired effects of putting rotating stresses on the magnets and dispersing the thermal energy, among others. Drying of items is usually accomplished through the use of heat, which facilitates the evaporation of humidity. In many applications, particularly when dealing with foodstuff (i.e. Coffee and Cocoa beans) as well as with delicate items of clothing, a tradeoff must be reached, wherein too high a temperature (which would facilitate drying) would damage the item being dried. Similar limitations exist when drying fruit. This results in significantly longer drying times. In addition, Hydrogen and Oxygen are traditionally generated via electrolysis, in which the passage of a direct current through an ionic substance that is either molten of dissolved in a suitable solvent results in a chemical reaction at the electrodes and the separation of materials. By encasing the electrodes in separate chambers, the gases are maintained separated. Unfortunately, this process is energy intensive. Over 90% of the hydrogen currently generated across the globe is made using natural gas found in fossils fuels, which of course has all the disadvantages associated with a large carbon footprint.

The present invention generally relates to inducing heat onto surfaces with metallic components from either permanent magnets or electromagnets in various configurations, and then generating hydrogen from a device and method for gasifying the humidity in the air or on any wet element through the application of air, heat and magnetic fields. Such a process would be useful for the drying of clothing, grain, food and other industrial uses. In a separate implementation, measure addition of moisture to the air or gas in the system could be used to generate hydrogen and/or oxygen via a gas separator, such as the membrane units in use today. The magnetic fields used may be built using electromagnetic and/or permanent magnets. In addition, the present invention generally relates to the gasification of moisture within a gas by the separation of the water molecules present in it into their separate hydrogen and oxygen components through their gasification when heated and subjected to a magnetic field generated via electromagnetic or permanent magnet mechanisms.

There is a need in the art for a system and method to facilitate the drying of items while at the same time generating hydrogen and/or oxygen, one in particular that would have a small carbon footprint while also using renewable resources by using magnetic heat generation.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about an induced magnetic field oxyhydrogen generator apparatus comprising a hollow cylinder with magnetic field generating components placed around said cylinder concentric longitudinal axis, one or more orbital pipes located inside said hollow cylinder, so that each said orbital pipe is capable of rotating along said hollow cylinder's concentric longitudinal axis, with each said orbital pipe having at least one metal portion directly exposable to the magnetic field generated by said hollow cylinder magnetic field generating components, wherein one or more of said orbital pipes is freely rotatable about said pipe's concentric axis of rotation, wherein said axis of rotation is parallel to and offset from the longitudinal axis of said magnetic cylinder, and located inside the inner surface of said hollow magnetic cylinder so that any rotation of each said orbital pipe is due solely to the effect of the magnetic field induced on said orbital pipe by said magnetic cylinder rotation, a mechanism for rotating said magnetic cylinder around the magnetic cylinder's longitudinal axis, one or more pipes for input of moist gas into said generator and one or more pipes for directing all or portions of said generator's oxyhydrogen exhaust. In another aspect, said magnetic field generating components are comprised of alternating N-pol and S-pol permanent magnets. In yet another aspect, said orbital pipes are comprised of ferrous metals. In another aspect, said orbital pipes are comprised of non-ferrous metals. In yet another aspect, said orbital pipes are comprised of a combination of ferrous and non-ferrous metals.

In one aspect, the invention is about an induced magnetic field oxyhydrogen generator system comprising a series of conduits connecting one or more chambers, one or more said chambers containing gas heating components, one or more said chambers containing gas moving components, one or more said chambers containing moisture creating components, one or more said chambers contain a magnetic field oxyhydrogen generator apparatus comprising, a hollow cylinder with magnetic field generating components placed around said cylinder concentric longitudinal axis, one or more orbital pipes located inside said hollow cylinder, so that each said orbital pipe is capable of rotating along said hollow cylinder's concentric longitudinal axis, with each said orbital pipe having at least one metal portion directly exposable to the magnetic field generated by said hollow cylinder magnetic field generating components, wherein one or more of said orbital pipes is freely rotatable about said pipe's concentric axis of rotation, wherein said axis of rotation is parallel to and offset from the longitudinal axis of said magnetic cylinder, and located inside the inner surface of said hollow magnetic cylinder so that any rotation of each said orbital pipe is due solely to the effect of the magnetic field induced on said orbital pipe by said magnetic cylinder rotation and an outlet pipe taking all or a portion of said magnetic field generator output oxyhydrogen and diverting it outside the system. In another aspect, said magnetic field generating components are comprised of alternating N-pol and S-pol permanent magnets. In yet another aspect, said orbital pipes are comprised of ferrous metals. In another aspect, said orbital pipes are comprised of non-ferrous metals. In yet another aspect, said orbital pipes are comprised of a combination of ferrous and non-ferrous metals.

In another aspect, one or more said chambers containing product drying components; wherein said product drying components; are comprised of a drying tumbler assembly comprised of solid wall insulated housing having within it a rotating tumbler made from a mesh material and having porous walls, said rotating tumbler having one or more angled blades having a scoop shape that avoids right angles at any point, each blade having a curved blended base with no sharp angles at the blade base to said rotating tumbler, forming a constant radius curve shaped blade base on both sides of said blade base so that each blade lifts and drops portions of the product within said tumbler to create a product cascade past an airflow stream going horizontally from an entry opening located ona side of said solid wall insulated housing to an exit opening located on an opposite side in said tumbler assembly's solid walls, both said openings being connected to portions of said series of conduits, said solid walls also having one or more venting openings at said walls' top, for venting of portions of said airflow stream out of said series of conduits and into the atmosphere, said gas moving components are comprised of a fan. In yet another aspect, said magnetic field generating components are comprised of alternating N-pol and S-pol permanent magnets. In another aspect, said orbital pipes are comprised of ferrous metals. In yet another aspect said orbital pipes are comprised of non-ferrous metals. In another aspect, said orbital pipes are comprised of a combination of ferrous and non-ferrous metals.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 shows an illustration of the internal rotating magnetic core of a magnetic field heat generating device according to an exemplary embodiment of the invention.

FIG. 2 shows an illustration of the external armature, including rotating satellites, of a magnetic field heat generating device according to an exemplary embodiment of the invention.

FIG. 3 shows an illustration of the magnetic field induction and magnetic field induced heating effect on a neighbor free rotating cylinder according to an exemplary embodiment of the invention.

FIG. 4 shows a front view of an internal rotating magnetic core and the corresponding rotating magnetic field induced heat generation (satellites) of a magnetic field heating device, according to exemplary embodiments of the invention.

FIG. 5 shows a front view of an external rotating magnetic core and the corresponding rotating magnetic field induced heat generation in the internal free rotating cylinders, according to exemplary embodiments of the invention.

FIG. 6 shows a side view of the external rotating magnetic core and the corresponding rotating magnetic field induced heat generation in the internal free rotating cylinders, according to exemplary embodiments of the invention.

FIG. 7 shows a front view of a heat and gasification module with cooling components, according to exemplary embodiments of the invention.

FIG. 8 shows a front view of a heat and gasification module, according to exemplary embodiments of the invention.

FIGS. 9 and 10 show details of axles, according to exemplary embodiments of the invention.

FIG. 11 shows a front view of the axle moving within the magnets, according to exemplary embodiments of the invention.

FIGS. 12-13 show a top view of the heat and gasification modules, according to exemplary embodiments of the invention.

FIG. 14 shows a front view of a geared heat and gasification module, according to an exemplary embodiment of the invention.

FIG. 15 shows a front view of a heat and gasification module, according to an exemplary embodiment of the invention.

FIG. 16 shows a top view of a heat and gasification module, according to an exemplary embodiment of the invention.

FIG. 17 shows a system view of a heat and gasification system, according to an exemplary embodiment of the invention.

FIGS. 18 and 20 show hydrogen separation and heating modules, according to exemplary embodiments of the invention.

FIG. 19 shows a front view of a geared heat and gasification module, according to an exemplary embodiment of the invention.

FIG. 20 shows a side view of a drying tumbler assembly system, according to an exemplary embodiment of the invention.

FIG. 21 shows a top view of a drying tumbler assembly system, according to an exemplary embodiment of the invention.

FIG. 22 shows a top view of one proposed hydrogen separation apparatus, according to an exemplary embodiment of the invention.

FIG. 23 shows a side view of a hydrogen separation apparatus, according to an exemplary embodiment of the invention.

FIG. 24 shows a side view of a double hydrogen separation apparatus, according to an exemplary embodiment of the invention.

FIG. 25 shows a top view of a hydrogen separation system, according to an exemplary embodiment of the invention.

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

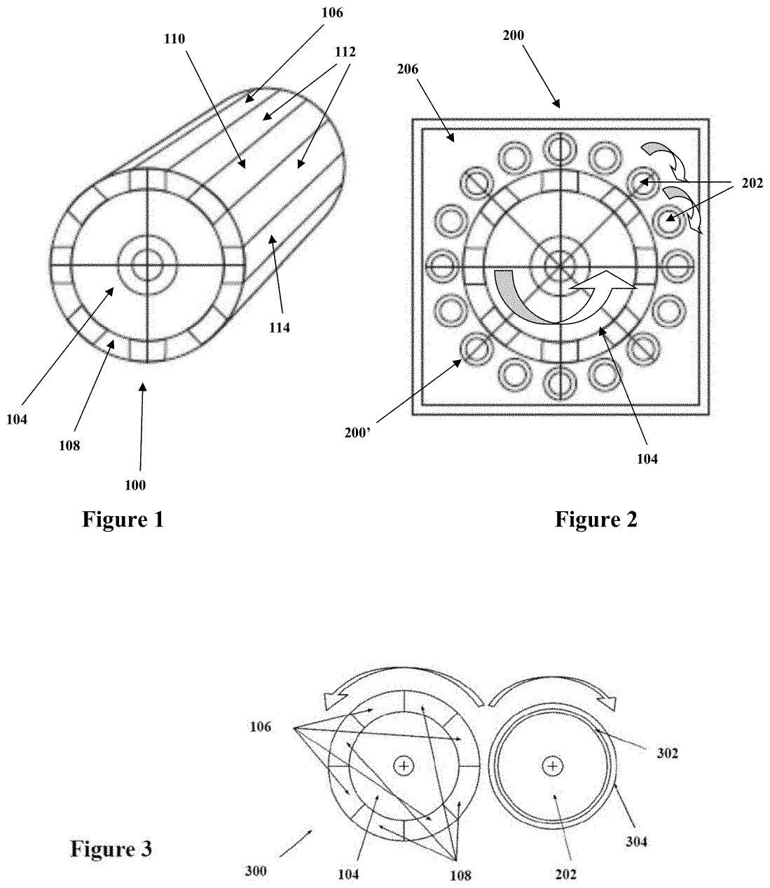

Referring to FIGS. 1-2 we see an illustrative exemplary embodiment of a rotating magnetic field heat generator having an interior rotating magnetic field generator 100 and an external static armature 200 comprised of individually free rotating cylinders 202/202′ unto which the heat is induced. (Note we say cylinder, but any similar and/or significantly cylindrical object (such as a hexagon/octagon/etc., and/or reasonably similar spherically cross sectioned object may suffice).

The orbital tubes or pipes (202) rotate freely themselves and surround a rotating permanent magnet assembly cylinder 104, whose magnetic surfaces are made of alternating N-pol (106, 114, etc.), S-Pol (108, 110, etc.) permanent magnets and optionally interposed phenolic 112 or other magnetic neutral materials. Said phenolic material may be used in other embodiments, as a way to save on magnetic material yet build appropriate structures. In order to preserve the energy generated, insulating material 206 fills the voids. In an alternate embodiment, one or more electromagnetic windings may be used to generate the magnetic field, obviating the need for permanent magnets, as well as for the rotation of the magnetic field generator (both internal and external field generators as seen below).

Note that in defining North or South polarity on a permanent magnet, we are using the “North” pole of a magnet as defined by the National Bureau of Standards (NBS) convention. Said convention is based on the following: “The North Pole of a magnet is that pole which is attracted to the geographic North Pole. Therefore, the North Pole of a magnet will repel the north seeking pole of a magnetic compass.” Its significant opposite is the South Polarity.

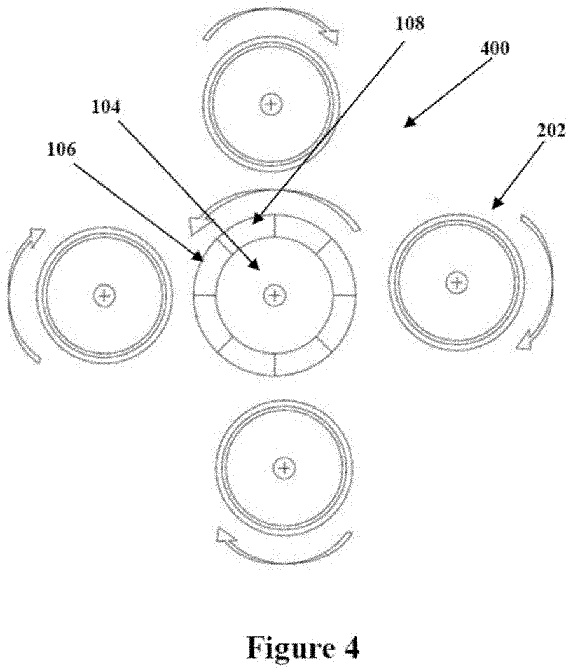

In one embodiment, the orbital pipes (202) are metal, or metal lined (be they ferrous or non-ferrous metals). In one embodiment, as with the exemplary embodiment shown in FIG. 4, the outside of the orbital tube is comprised of a ferrous metal, while the inside is lined of a non-ferrous metal. In an alternate embodiment, it is the reverse, with the non-ferrous material being on the outside. The non-ferrous material may be a metal like aluminum or copper, or it may also be a phenolic material like polymers (plastics), wood, or others.

In an alternate embodiment, the orbital pipes are made of a non-metallic material (for example PVC), but contain either an internal metallic lining, an internal hollow tube of lesser diameter made of metal, or simply a solid metal rod. In an alternate embodiment, the metal rod within the non-metallic tube is itself encased in a plastic shell or sheathing, to minimize interaction with the fluid travelling within it. The magnetic flux hears the metallic portion, which proceeds to heat the fluid within (be it water, air or oil).

As in FIG. 4, the orbital pipes or tubes in FIGS. 1-2 may be designed so that one or more of them rotate along a central orbital axis. This allows for a reduction in magnetic field losses (and hence higher system efficiency). The orbital tube rotation may be mechanically induced (through friction with the internal rotating cylinder 104), or through other mechanical means such as belts connected to other motors, or the motor generating the rotation of the central cylinder 104.

They may also be antipodally paired (cylinder 202 with its diametrically opposite another similar cylinder), to match the heat being induced within them, without all of them being identical. This would ensure the heat induced on the fluid within pair 802-807 is not necessarily identical to that in the pair 803-805. Similarly, the rate of rotation may be similarly accelerated or slowed down (via separate mechanical means) to generate some of the same pairing temperature difference.

In another embodiment, the fluid being passed through certain orbital tubes may not be identical. In that form, one or more orbital tubes may be dedicated to generating air heating (for a forced air system), while others are dedicated to heating water for a water heater.

In one embodiment, the pipes are metal, or metal lined (be they ferrous or non-ferrous metals). In an alternate embodiment, the tubes are made of a non-metallic material (for example PVC), but contain either an internal metallic lining, an internal hollow tube of lesser diameter made of metal, or simply a solid metal rod. In an alternate embodiment, the metal rod within the non-metallic tube is itself encased in a plastic shell or sheathing, to minimize interaction with the fluid travelling within it. The magnetic flux hears the metallic portion, which proceeds to heat the fluid within (be it water, air or oil).

The principle of heat induction is best seen in FIG. 3. A rotating magnetic field induction heater 300 is shown. A permanent magnet first cylinder 104 containing a series of alternating permanent magnets on its periphery (N-pol 106, S-pol 108) is rotated (counterclockwise direction is shown, but either direction may be used) to accomplish the desired magnetic flux variation. In an alternate embodiment, phenolic material may be interspersed with between the N-pol, S-pol magnets.

A second cylinder 202 made of a combination ferrous 302 and non-ferrous 304 materials is located in a significant parallel arrangement to the first cylinder. In one embodiment, the inner layer of the cylinder is made of ferrous materials, and the outer layer or skin is made of non-ferrous materials. In an alternate embodiment, the order is reversed, with the non-ferrous material being on the outside. In another embodiment, outer layer is made of a non-metallic material, such as plastic or carbon fiber. In an alternate embodiment, one or more second cylinders surround the first cylinder, all receiving induced heat from the rotating magnetic flux.

In one embodiment, the second cylinder is made to rotate in the opposite direction (Clockwise (CK) if the first is going Counter-Clockwise (CCK), CCK if the first is going (CK)). In yet another embodiment, they are going in the same direction (CK to CK, CCK to CCK). Rotation of the cylinders may come from the same mechanical means (motor, gears, etc.), or from separate means. In one embodiment, one of the cylinders may be made to rotate, and the contact between the first and second cylinder used to rotate the second.

As before, the magnetic flux change induced on the second cylinder generates heat. In one embodiment, the heat is removed by a fluid (liquid or gas) flowing through the inside of the second cylinder. In an alternate embodiment, the complete assembly is submerged in the fluid, and the heat generated is communicated to the surrounding fluid.

In an alternate embodiment, exemplary illustrated in FIG. 4 a rotating induction heater assembly 400 is shown. A permanent magnet inner cylinder 104 containing a series of alternating permanent magnets on its periphery (N-pol 106, S-pol 108) is rotated (counterclockwise direction is shown, but either direction may be used) to accomplish the desired magnetic flux variation. In an alternate embodiment, phenolic, plastic or non-ferrous material may be interspersed with between the N-pol, S-pol magnets.

One or more orbital cylinders 202 made of a combination ferrous and non-ferrous materials is located in a significant parallel arrangement to the first cylinder. In one embodiment the inner layer of the cylinder is made of ferrous materials 302, and the outer layer or skin is made of non-ferrous materials 304. In one embodiment, all cylinders are made like this. In an alternate embodiment, the order is reversed, with the non-ferrous material being on the outside.

In one embodiment, all the orbital cylinders are made this way. In an alternate embodiment, the orbital cylinders are paired, so that antipode cylinders are made of similar materials, but not all pairs are identical in makeup. In this way, a system having a central or inner cylinder rotating at a constant speed, may induce different temperatures in the fluids contained within the various pairs of orbital or outer cylinders.

As before, the magnetic flux change induced on one or more of the orbital cylinders generates heat. In one embodiment, the heat is removed by a fluid (liquid or gas) flowing through the inside of the orbital second cylinders. In an alternate embodiment, the complete assembly is submerged in the fluid, and the heat generated is communicated to the surrounding fluid.

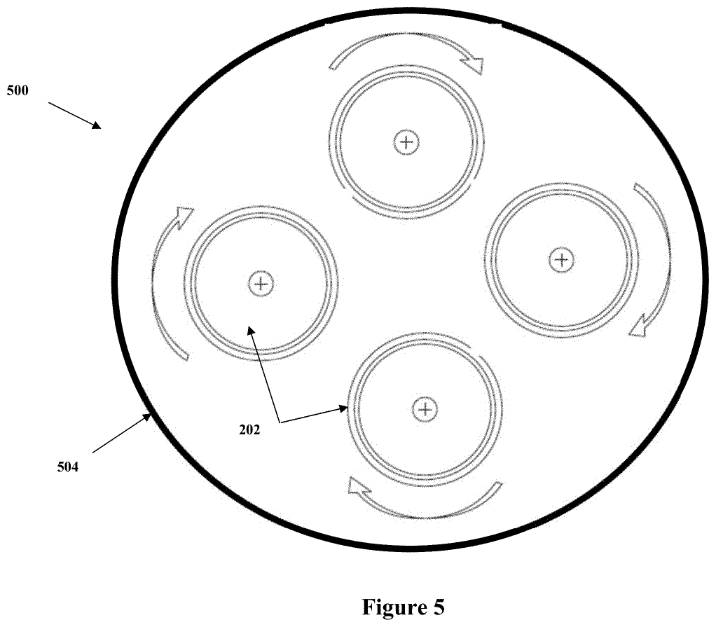

Note that the rotating magnetic field unit need not be only in the inside. In another embodiment shown in FIG. 5, the element containing the alternating polarity permanent magnets 500 is placed in a ring 504 containing the one or more orbital elements 202 within its interior. The ring may be rotating (comprised of permanent magnets and/or electric magnetic inducing coils) and or stationary and comprised of electric magnetic induction coils. Similarly, the orbital elements 202 are stationary, while in an alternate embodiment, they are rotating. This rotation may be self-induced (i.e. free), or mechanically/electrically produced to match that of the outer ring.

The orbital rings may be of construction similar to that of those illustrated in FIG. 3 or FIG. 4, that is, as a sandwich of ferrous 302 materials within non-ferrous materials 304, or vice-versa, with the ferrous material on the outside. As before the rotations may match, or be counter (assisted via mechanical/electrical means).

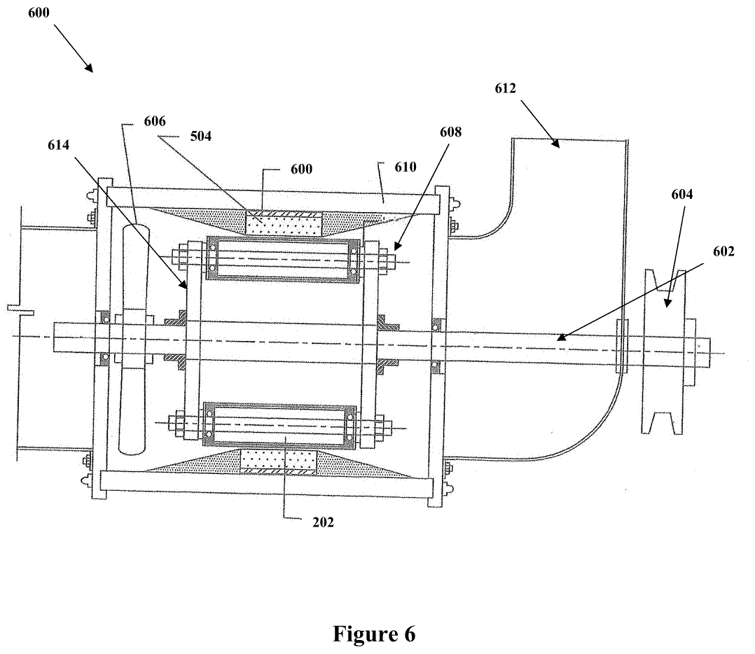

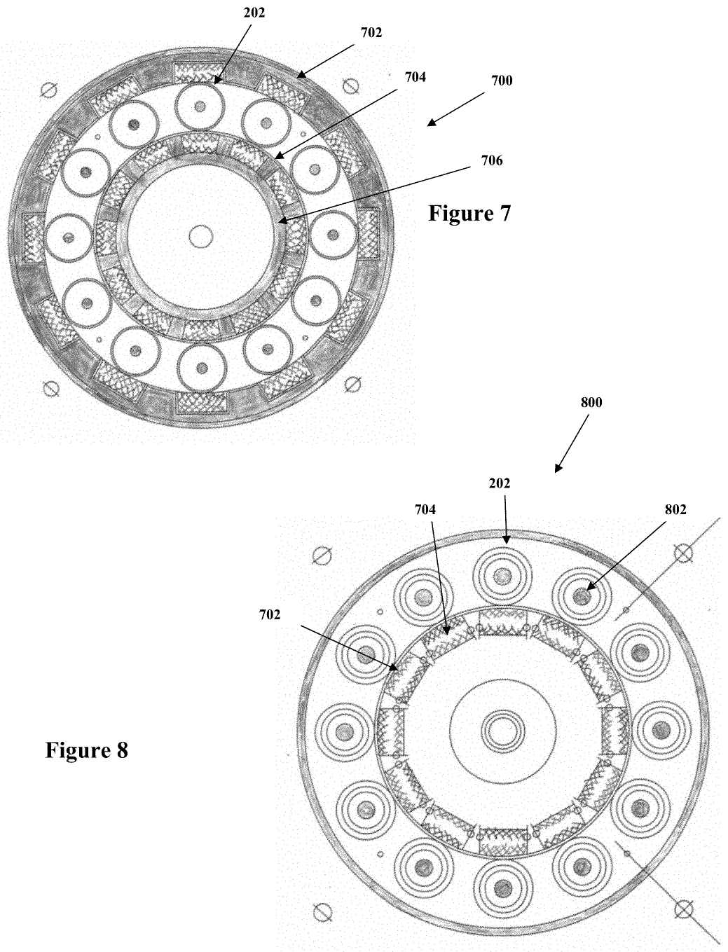

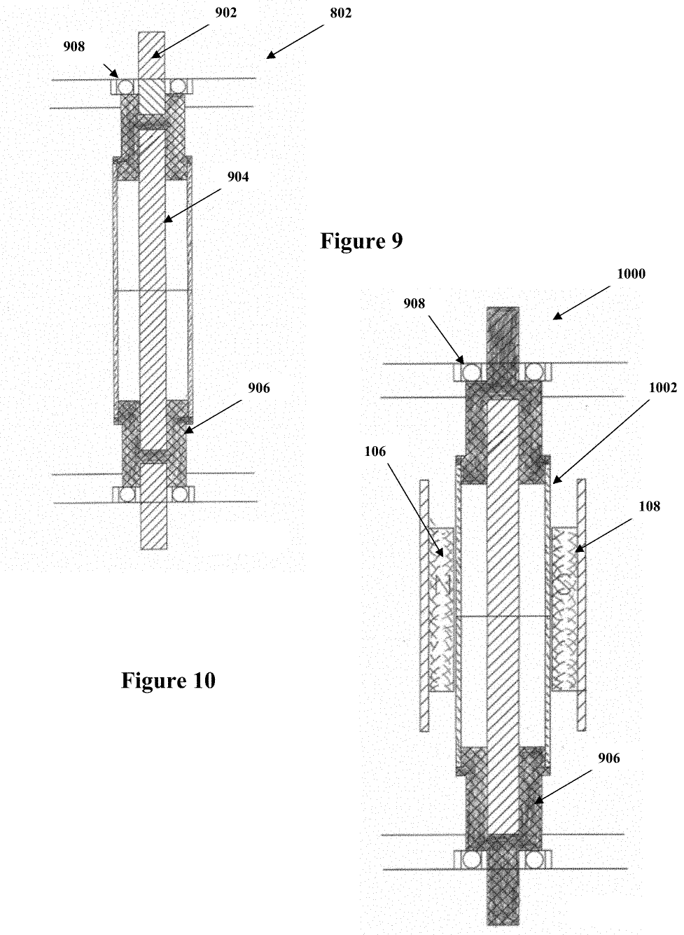

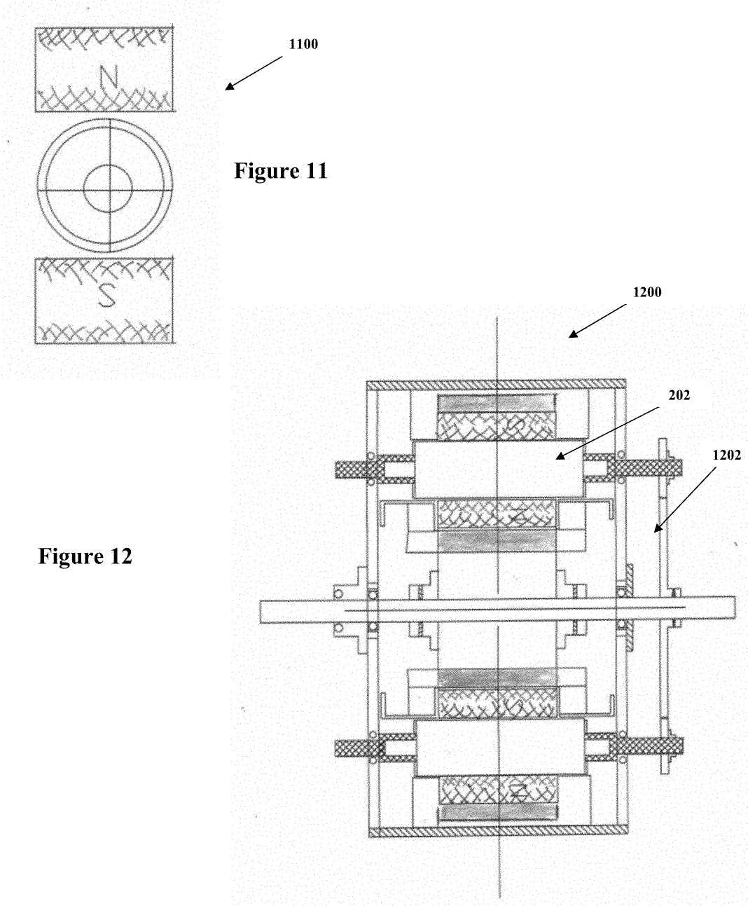

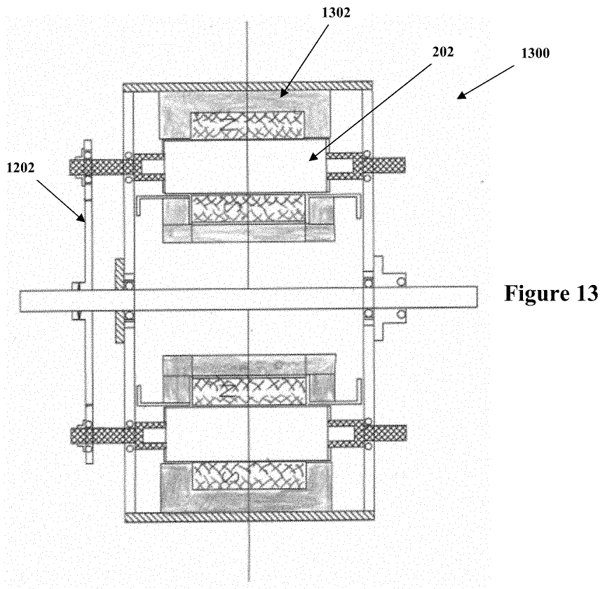

FIGS. 6-16 illustrate an illustrative embodiment of an external magnetic ring unit 600 having a magnetic ring 504 comprised of permanent magnets mounted on a fixed frame 610, with one or more internal rotating skeleton(s)/frame(s) 614 which holds the satellite orbital elements 202 and is made to rotate (by being connected to a rotating central axle 602 coupled to a belt spindle 604 of another motor/engine, and/or directly coupled). In one embodiment, said orbital elements 202 are themselves left to rotate freely around each individual central axle 608 (with the rotation of the elements 202 being induced by the magnetic field). In an alternate embodiment, the satellites 202 are rotated through other components (mechanical or electrical), and finally in yet another embodiment they are fixed and non-rotational.

Depending on the fluid used for heat transfer (be it air and/or gas mixture, liquid or combination), the unit 600 may be housed as part of a series of pipes/ducts 612 and the rotation of the central axle 602 used to move a fan or propeller 606 that moves said fluid both around and through the pipes 608 serving as the axle for the satellites 202, which spins on one or more ball bearing couplings.

We see in a number of embodiments of improved heat and gasification magnetic engines. In one embodiment 700, an outside ring 702 and an inside ring 704 of alternating N-Pol/S-Pol permanent magnets rotates around one or more rotating orbital tubes or pipes 202. One or more refrigerant fluid channels 706 (liquid or gas) may be used to lower the operating temperature of the assembly as the heat if generated. In another embodiment 800, the orbital tubes 202 are geared so as to have phenolic axle materials 802 extending from their center.

In a similar multi-orbiting cylinder embodiment, seen in an illustrative exemplary embodiment in FIG. 8, another embodiment of the magnetic field generator is 600 is illustrated 800. Orbital tubes or pipes (802, 803, 805, 807 and others) rotate around their longitudinal axis and surround a rotating permanent magnet assembly cylinder 804, whose magnetic surfaces are made of alternating N-pol (806, 814, etc.), S-Pol (808, 810, etc.) permanent magnets and optionally interposed phenolic 812 or other magnetic neutral materials. Said phenolic material may be used in other embodiments, as a way to save on magnetic material yet build appropriate structures. The complete assembly may be housed within a pneumatically sealed duct 820 suitable to keep the moisture laden air coming from the blower/fan 606 flowing.

The disclosure of the aforementioned Wachsman et al. U.S. Pat. No. 6,235,417 is herein incorporated in its entirety. In Wachsman et al, a two-phase conductor is shown which are useful in the present invention and in which a metal such as palladium is used as an independent phase in the conductor. However, in addition to palladium and its alloys, other metals which may be used in this invention include Pt, Fe, Co, Cr, Mn, V, Nb, Zr, Ta, V, Ni, Au, Cu, Rh, and Ru.

The hydrogen conducting membrane may also include an oxide of the ABO₃ formula wherein A is selected from the group consisting of Ba, Ca, Mg and Sr (generally the alkaline earth metals) and B is Ce₁₋ₓMₓ or Zr₁₋ₓMₓ or Sn₁₋ₓMₓ, where x is greater than zero and less than one and M is selected from Ca, Y, Yb, In, Gd, Nd, Eu, Sm, Sr, Mg and Tb. As disclosed in patent application Ser. No. 09/192,115, filed Nov. 13, 1998 entitled Proton-Conducting Membrane Comprising Ceramic, A Method for Separating Hydrogen Using Ceramic Membranes, the entire disclosure of which is herein incorporated by reference.

Mixed oxides of the type disclosed therein in which the oxide is of the general formula ABO₃ wherein A is selected from the group consisting of Ba, Ca, Mg and Sr and B is selected from Ce, or Zr, or Sn, which may or may not be doped wherein the dopant is selected from Ca, y, Yb, In, Nd, Gd, Sr and Mg or combinations thereof are also useful in the present invention. Moreover, the catalytic metal in the above-disclosed mixed oxides may be selected from Pt, Pd, Fe, Co, Cr, Mn, V, Nb, Zr, Y, Ni, Au, Cu, Rh, Ru, their alloys and mixtures thereof. These membranes are useful for selectively transmitting protons, wherein the membrane has a thickness of between about 0.025 and about 5 millimeters.

In addition to membranes which transmit protons, as illustrated in the aforementioned '417 patent and the aforementioned '115 application, membranes made of certain metals will selectively transport atomic hydrogen. These are single phase membranes and include membranes of Pd, Nb, V, Ta, Zr, their alloys and mixtures thereof. Metals such as those above noted may be supported or unsupported. When supported, the membranes may be supported by an oxide or another metal, for instance, alumina as well as yttria stabilized zirconia or SiO₂ may be used as oxide ceramics to support the above-mentioned metals. In alternate embodiments, other metals may be used as supports for the above-identified metals, for instance, Cu may be used as a support metal for Nb.

Other methods and systems for this separation include those proposed by Kongmark et al (U.S. Pat. No. 7,935,254) or Lee et al (2004/0050801) may be used. In one embodiment, an additional heating element may be present in the portion of the system before its introduction to the membrane atomic separator to facilitate its operation. In all cases, the passing of the humid gas through the magnetic field aids substantially in the separation of the hydrogen/oxygen in the water molecules.

The axles can be appreciated 802 when looking 900 at the central non-ferrous axle 902, 904 held by a ball-bearing 908, coupled to a phenolic material assembly 906. The assembly 1000, held in place by one or more ball-bearings 908, allows a rotating tube 1002 to move within the magnetic field generated by the N-Pol/S-Pol magnets 106/108. that may be static. The top view can be seen in 1100.

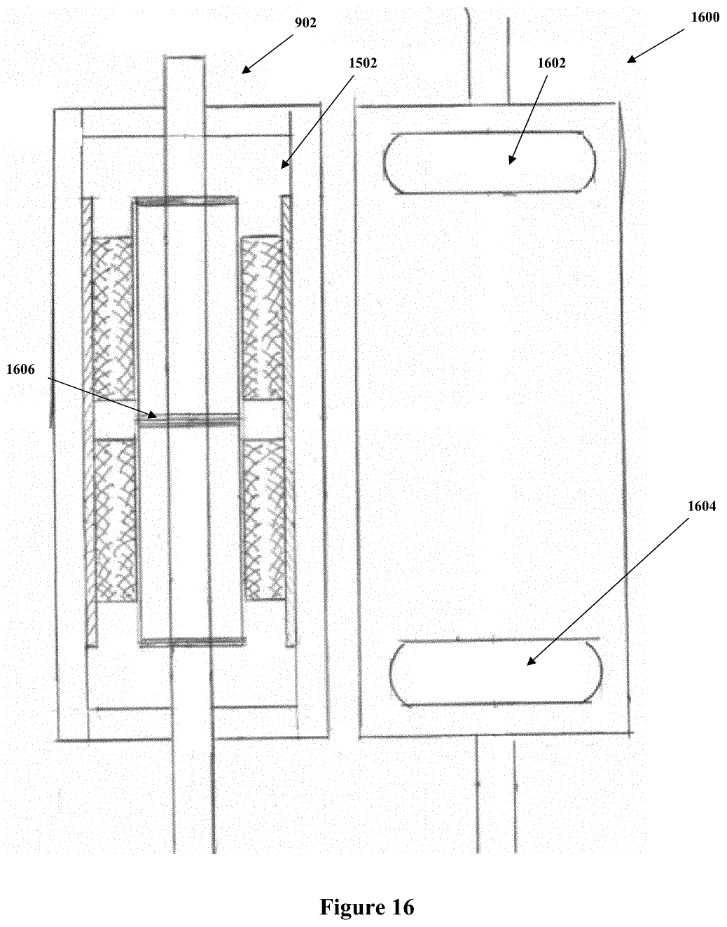

In certain applications 1200, there may advantages to having a transmission mechanism 1202 rotate the orbital tubes or pipes 202 at a different speed than that induced on them by the magnets. In an alternate embodiment 1300, one or more fluid channels 1302 may be used to cool the orbital tubes 202. In an alternate embodiment 1400, the orbital tubes 202 are configured to be mechanically geared 1402 and coupled to the rotating magnetic ring 1404. As is the case in FIG. 5, the assembly (FIG. 15) may be such 1500 that the N-Pol 106 and S-Pol 108 magnets rotate around a center tube 1502. In such (FIG. 16) an assembly 1600, the air comes in 1602 and exits heated through 1604 after traveling through the inside 1606 of the assembly.

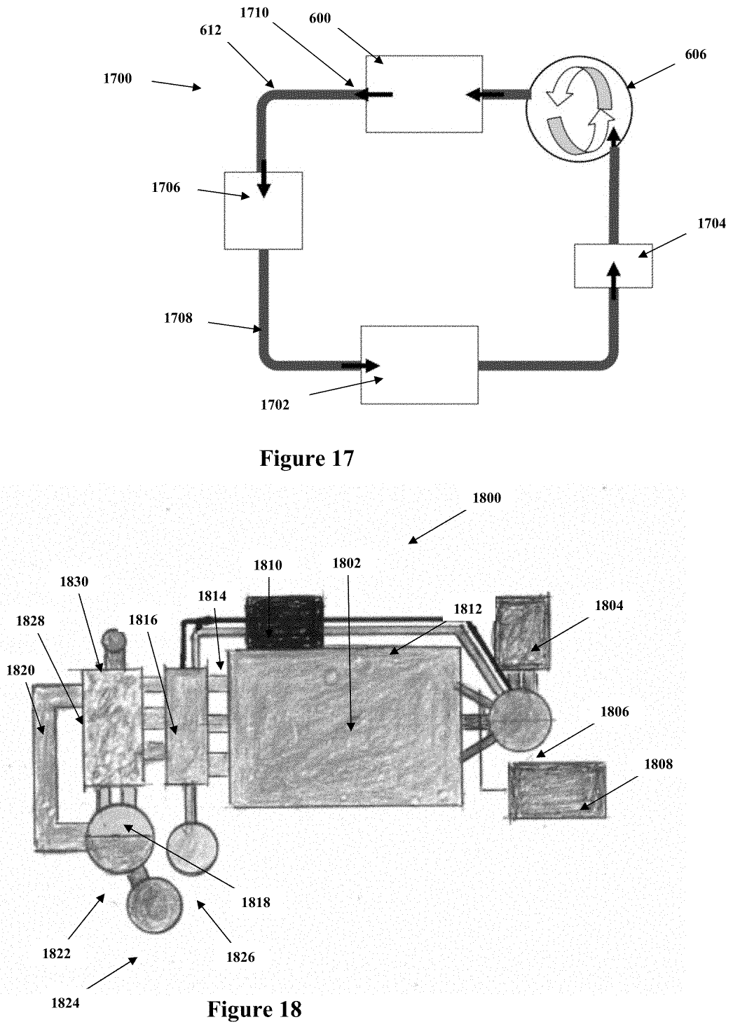

To use the present invention as either a heater, a drier and/or a hydrogen generation system, we refer to FIGS. 17-19, in which a system 1700 for removing moisture from a material, said system having optional components for generating both hydrogen (and oxygen) and/or HHO, through the separation of water molecules (H₂O). This conversion of mechanical energy into chemical energy lies at the heart of the unit. In general, the system operates by making a gas containing a variable amount of moisture travel through a series of chambers via pneumatically connected tubes, channels or conduits 612.

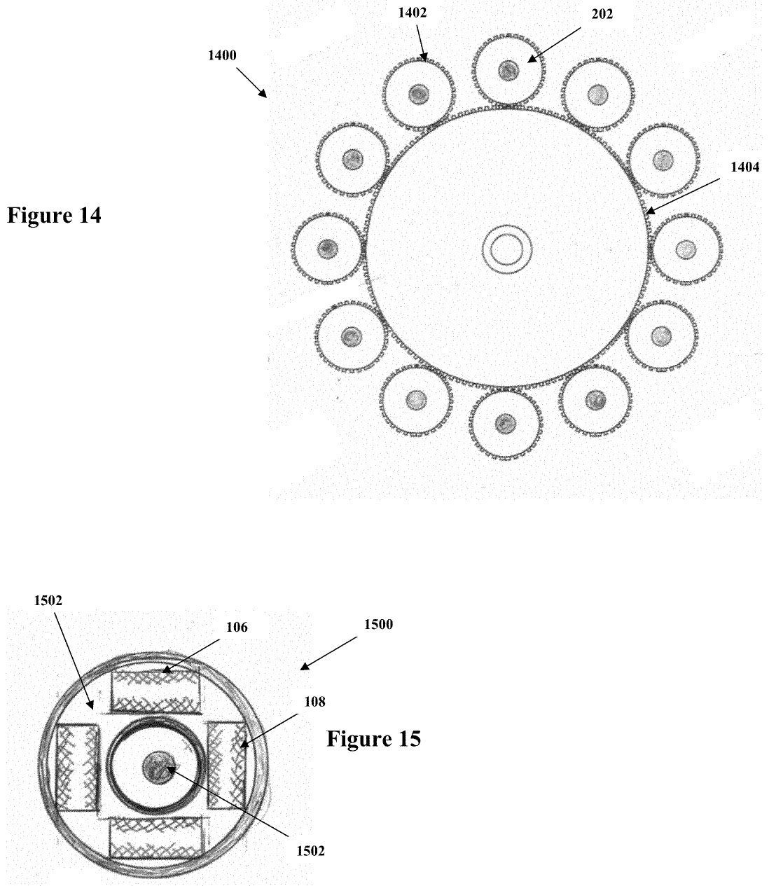

The presence of an alternating magnetic field induces a temporary magnetic field within he aluminum and other non-ferrous metals. The ability of the cylinders to rotate freely reduces the back-EMF and increases the thermal heat generated while reducing back forces. However, as shown in FIG. 14, the mechanical coupling of rotation may increase certain efficiencies, particularly when the gearing is coupled to the expected mechanical momentum at certain speeds.

What we have found, is that the circular motion of the tubes, in addition to generating the heat, has the added advantage (as the combination of all or parts of the heat, moisture, aluminum, magnetic field shear [that quick passing from one magnetic field to the other resulting from both movement of the air AND/OR movement of the magnetic fields]) of converting the mechanical motion to chemical separation of the H₂O molecules.

Thus, at the moment the humidity in the air/gas goes through the magnetic field within the magnetic heater 600 assembly, a temporary separation of the H₂O molecules occurs to a percentage of the water vapor. This creates a well-known separate gas, Oxyhydrogen (HHO). HHO is a combustible gas that may be burned by itself, or from which hydrogen may be separated.

HHO (normally produced via electrolysis) is present at combustible ratios at the exhaust vent 1604 of the magnetic heater 600 when proper humidity is maintained. In addition, the presence of aluminum (from which many components are fabricated) increases the HHO generated.

The above offers a number of advantages, by connecting a portion of the exhaust gases coming from the exhaust vent 1604 to a pipe, this may be used to power an internal combustion or jet turbine to turn the magnetic unit itself.

In one embodiment, the gas being used is air, in an alternate embodiment, it may be a pure gas, including hydrogen or oxygen, or any mix of any other gas, preferably one heavier than oxygen to facilitate the separation of oxygen and the hydrogen.

When used primarily as a dryer of a material in chamber 1702, the conduits 612 are preferably made with connections that will facilitate the escape of separated hydrogen molecules in the first section following the magnetic field generator chamber 600. The air is moved around the assembly 1700 via gas moving means apparatus, preferably a blower or fan assembly 606. This moves the gas through the system components, including into the magnetic field generator chamber 600. In an alternate embodiment, a humidifier is placed on chamber 1702 in order to provide the water molecules to be separated by the magnetic field generator chamber 600.

The optional heating chamber 1704 may be solar powered, or through the burning of carbon matter (coal, wood, oil, natural gas), or electrically heated. In an alternate embodiment, the hydrogen generated by the optional atomic separator 1706 may be fed into a burner to generate heat for the heating chamber 1704.

When a moisture laden gas mixture (preferably air, but other embodiments may utilize any particular gas) is subjected to a magnetic field generated by a magnetic field generator 600, all or some of the water molecules break up into their individual Hydrogen and Oxygen components. In one embodiment, this breakup causes the humidity in the gas to be reduced, and when the hydrogen is allowed to escape, a resulting drying effect occurs. The presence of aluminum acts as a catalyst in improving the yield of hydrogen. Other non-ferrous metals would probably assist similarly. For cases where only drying is desired, the escape of hydrogen atoms following the magnetic field 600 produces a significantly dryer gas, which may then be recycled to restart the drying process of the material placed on chamber 1702.

This split is partly due to mass differences, and partly due to a combination of the Zeeman and Paschen-Back effects on the actual atoms. As a result, for a period of time, there is a temporal separation between the oxygen and hydrogen atoms. At this point in the process, any of a variety of atomic separators may be used. In an alternate embodiment, the optional separation of the hydrogen (or the oxygen) may be accomplished in one embodiment by moving the gas containing the separated water molecules through a separator 1706.

In one embodiment, the system operates in a closed loop mode, where air is taken into the system. In an alternate embodiment, it is a closed loop. The closed loop system is preferred, as it would minimize contamination to the other system components.

Whether recirculated or fresh, the gas being fed into the magnetic field generator 600 must be at an appropriate humidity. In one embodiment, a humidifier is placed within chamber 1702 and used to provide water from a reservoir of water. In an alternate embodiment, the humidification takes place via an ultrasonic transducer. In another embodiment, a sprayer is used. Yet another embodiment may us the wicking effect on a suitable surface across which the gas is forced. Note that the water being provided to the humidifying chamber may be optionally purified or filtered, in order to minimize the deposition of any particles at either the magnetic field generator 600, the optional heating chamber 1704 or the atomic separator 1706.

In an alternate embodiment (FIG. 18), the moisture supply may be any obtained by passing the dried gas stream through a combined gas and gasification module 1802 (optimally a combination of the field separator 600). A blower 1804 and a humidifier 1806, powered by a motor 1808 passing air through any material in need of desiccation. These materials may include harvested fruits or beans (e.g. coffee, cacao), tea leaves and woods; as well as house or industrial laundry, etc. By placing or passing the material to be desiccated in a chamber that feeds this module 1802, through which the dried gas stream travels, the natural occurring moisture taken from the material to be dried could be used to supply the moisture that generates the hydrogen/oxygen.

Of particular importance in drying, has been the ability of the Berdut magnetic field generator 1706 of raising the temperature of air from the 25-30° C. range (typical air temperature for coffee growing regions), to the range of 60-70° C., which is optimal for coffee/cacao beans, as its allow their drying without “cooking” them. In addition to water in the chamber, natural products such as these bring natural occurring sugars and alcohols, which are aided in the drying of the product by combining with any moisture.

The magnetic field generator being used by the system may be one of many embodiments. In one, it an electromagnet, such as those used in large electric motors and/or electricity generator sources (such as those in power plants). In effect, the area around the generator's armature would be sealed, and made part of the airflow. In the case of generation, the amount of humidity would be critical, as some of the equipment may deteriorate if exposed to too high a level. In any case, the design and/or retrofitting of existing units would allow for the generation of hydrogen/oxygen as an easy by-product of the generation of electricity. The hydrogen/oxygen generated could then be fed to the boilers in the plant together or separately.

The above is suitable for generators of up to 300 MW (which typically use air cooling). While care must be exercised vis-à-vis the humidity being used, the careful introduction of low levels of humidity (below 30%) would still reduce any corrosion while allowing for the by-product generation of hydrogen/oxygen. In large plants utilizing hydrogen cooling (typically 300 MW to 450 MW), the system could provide a ready source of hydrogen.

An additional heater unit 1810 (powered by fuels, electricity and/or by-products of the drying process (biomass, husks, etc.), which allows for the generation of additional heat that may be routed to the humidor 1806 through the heat channel 1812. The humid air goes through the gasification module 1802, which separates the Hydrogen and Oxygen atoms within the water molecules in said humid air. A radiator 1816 fed with cold fluid 1814 is used to rapidly chill the exhaust from said module 1802. This has the effect of stratifying the airflow, so that the heavier oxygen goes to the bottom 1818, and the hydrogen to the top 1820.

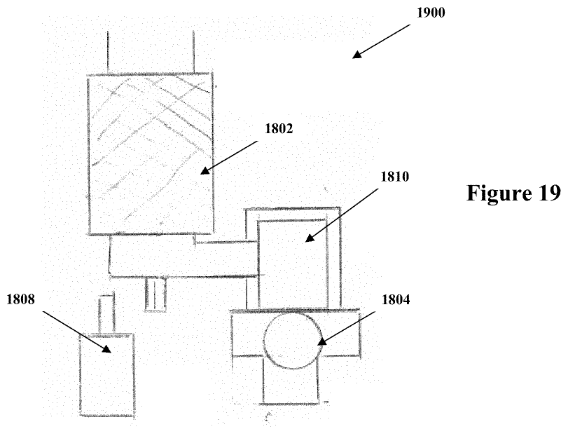

The freezer 1822 is used to then capture the hydrogen and store it into a hydrogen tank 1824. More water can be fed from the water tank 1826, and continue feeding the cooling module 1828, which has an oxygen leak 1830 in order to release Oxygen back to the atmosphere. In FIG. 19, we see a combined heat and gasification module 1900, where a motor 1808 powers a blower 1804 feeding a heater/oven 1810 for helping the gas get hotter before being fed into the gasification module 1802.

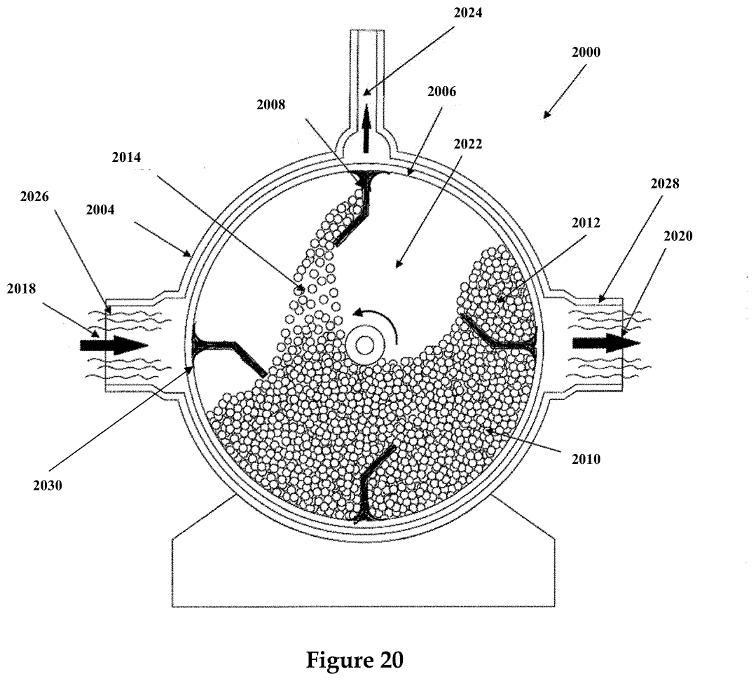

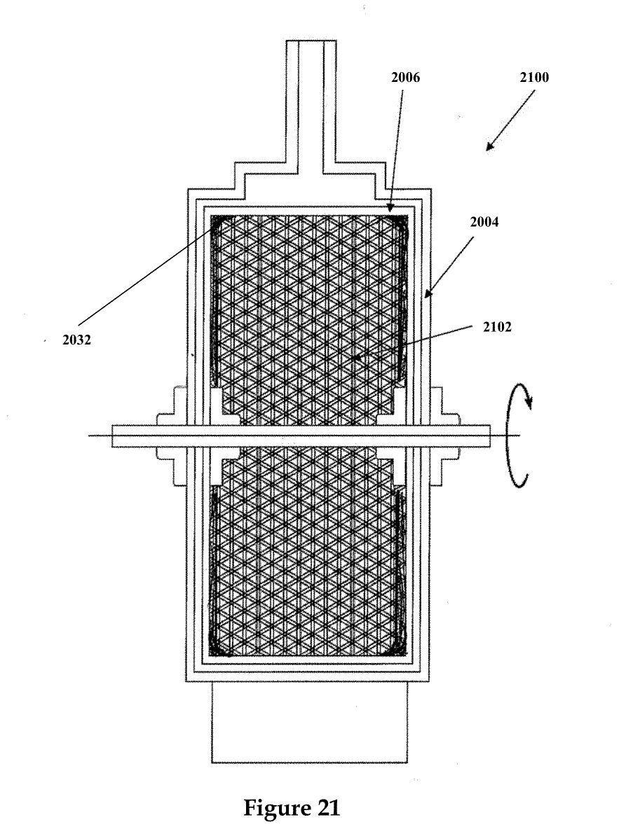

The gas or air conduits 612 interconnect the unit's components. The drying chamber 1706 is in one embodiment (FIGS. 20-21) a tumbler assembly 2000 (to facilitate the rotation of the product). Hydrogen and/or Oxygen is allowed to escape after the magnetic unit 600 via either naturally occurring leaks or a bypass valve built into the magnetic unit 600. In one embodiment, this is a valve that allows for the gas to escape on one side of the conduit while allowing air to come in through another, say with a venturi effect opening. A similar opening could be placed before and after the blower.

The revolving drying chamber or tumbler assembly from a side view 2000 as well as from a side view 2100. A solid wall insulated housing 2004 houses the rotating tumbler assembly 2006, creating a chamber 2022 for drying product. Within the tumbler chamber 2022 one or more mixing ribs, paddles or blades 2008 are provided with a scooping shape so as to elevate the product 2010 being dried. A critical element of the blade construction is the molded or blended base 2030. By avoiding right angles here as well as in any other juncture 2032, the product does not stick to these corners, avoiding burning or overcooking. The preferred embodiment is a constant radius curve.

In alternate embodiment, the angle of the blade or scoop may be made adjustable, so it may be optimized for the grain being dehydrated. In this fashion sufficient drying material is scooped and elevated 2012 to the upper portions of the tumbler to ensure the product then cascades 2014 past the airflow as it enters 2018 and exits 2020 the tumbler chamber. One or more walls of the tumbler are made to be porous, manufactured with a mesh material 2102 (be it metal, cloth or carbon composite) to allow for easy airflow past the product.

It is critical to point out that the drying material or product 2010 should not fill more than two thirds (⅔) of the chamber 2022. In one embodiment, the system is designed to be filled to approximately half (or less) of the tumbler volume, so that the external humidity or moisture in the product may be gasified quickly. This quick gasification of the external moisture is critical, else the product temperature may be raised too quickly by the hot air blowing through the tumbler. If not done, when drying the products such as coffee or cacao beans, there is a risk that you will ‘cook’ the beans, altering their flavor.

In the case of coffee, cacao and other similar grains, the husking process produces a humid bean surrounded by a sugar and starch membrane. This sticky membrane causes the clustering of the grains, which become hard to dry. They tend to stick onto any sharp corner, delaying the drying of the membranes not exposed to the airflow, which delays overall drying and may even cause the aforementioned ‘cooking’ of the grains.

In contrast, our system has a tumbler with rounded corners, polished surfaces, in combination with the product cascade limits or eliminates these clusters, producing a uniform drying action. This allows for the grains to be brought directly to the drying system without any pre-drying, saving time, energy and producing less contamination. In tests, the system has reduced the drying time from 24-48 hours to 4-6 hours, creating a uniform drying without compromising quality.

In one embodiment, one or more venting/exhaust or input openings 2024 are provided. These may be used to allow for the measured escape of a portion of the airflow directly into the atmosphere. In one embodiment, this opening is one or more fixed size openings. As a rule of thumb, the diameter of these openings should be a percentage of that of the entry 2026 and exit 2028 airflow openings, with a range of less than 1% to even bigger than the exit airflow opening 2028, depending on how much of a closed loop system is desired. Since the air moving means (i.e. blower) could be located past exit opening 2028, a percentage of air from the chamber would always be captured.

In an alternate embodiment, a fixed or automated damper or valve could be installed in series with the opening 2024. Such a variable opening could be adjusted to the time of drying, the material being dried (coffee vs. cacao), the temperature of humidity measured in the airflow, etc. through either automatic means (valves and actuators) or signals to an operator. The lightweight construction of the tumbler assembly 2000 would allow for the system to be easily transportable.

When using a Berdut magnetic generator 600 in one embodiment of 1300, the humidity passing through the chambers behaves in an interesting fashion while subjected to the thermo-magnetic effect of being both warmer and subjected to the passing magnetic fields. In effect, the Hydrogen and the Oxygen atoms in the vapor moisture separate, albeit in a temporary fashion, capturing the separate elements (hydrogen and/or oxygen) before they have a change to recombine, offers significant advantages in terms of costs. In effect, we do have a system capable of producing an energy generating gas (Hydrogen) from water. In one embodiment, the use of copper and/or aluminum parts in the magnetic generator 600 act as catalysts in accelerating the separation reaction.

In one embodiment, the input opening (say 2024) is coupled to an exhaust opening 1710 that takes a part of the HHO generated at the magnetic generator 600 while preserving the overall system 1700 pressure. Besides preserving the overall system pressure, additional humidity may be inserted in order to preserve the overall HHO production.

The elements being brought into action are steam, magnets, heat and gasification, which combined create the necessary conditions for the hydrogen/oxygen separation in the water. In one embodiment, the basic elements are heat and gasification. The magnetic generator 600 module may be comprised of either permanent magnets, electromagnetic arrangements and/or a combination thereof. In either case, they may be built with copper and/or aluminum components, in rotating assemblies built on axles having direct or indirect contact to the rest of the assembly. These assemblies may rotate along, across or at various angles to the airflow, creating a parasite current which we may term ‘parallel energy’. This parallel energy creates collisions creating heat, this heat is related to the speed with which the rotating assemblies are subjected to said magnetic fields, subjecting said air humidity to the heat and magnetic effects. This results in the breakup of the water molecules, separating the Hydrogen from the Oxygen in the water.

The above separation of the humidity (whether said humidity is coming from the drying of the goods and/or from additional water that is atomized or vaporized into the airstream) allows for the economic and efficient generation of hydrogen. The hydrogen may then be separated permanently by making the airflow (containing the separated hydrogen and oxygen (plus other gases in the normal atmosphere)) be presented to one or more membranes whose small porosity allows only the hydrogen to pass through. The oxygen and other gases not allowed through said membranes are then recycled, allowing for a continuous flow that is efficient in an energy fashion.

Note that when adding water to the above airflow, the water may have other hydrogen rich elements added to it in order to facilitate the hydrogen production. In one embodiment, the elements for the of the thermomagnetic effect are aluminum and/or coppern and movement. The generated heat may be useful to heat homes, commercial properties and factories, as well as cooking, drying of clothes and other uses. Said Berdut assembly 600 may be accomplished by a number of moving elements, including electric motors, internal combustion engines, hydraulic and pneumatic force, tides, winds and even animal force.

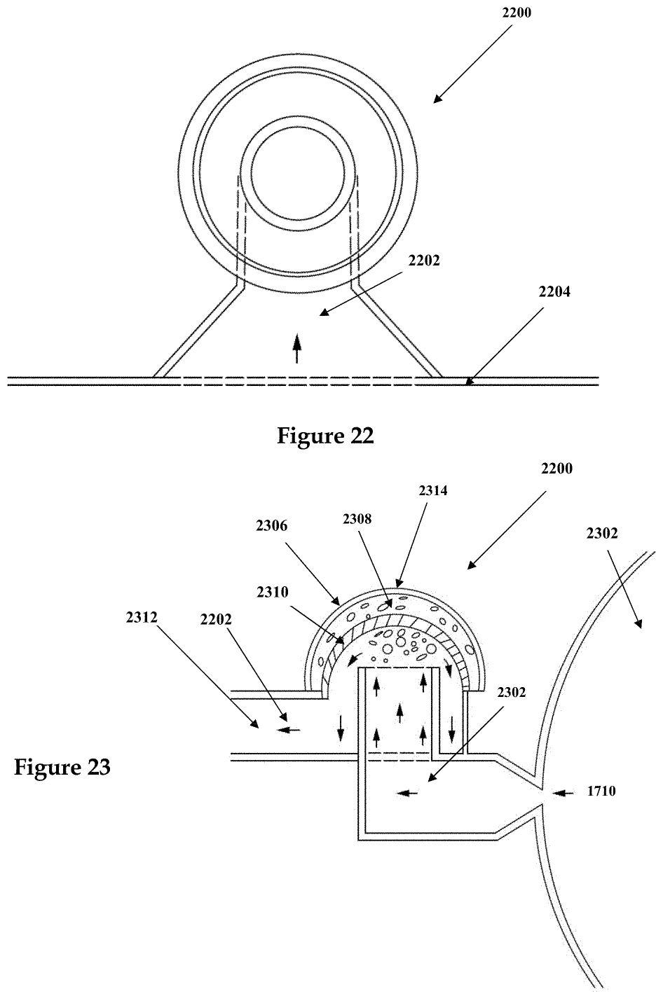

Referring to FIGS. 22-25 we see a top view of a proposed embodiment 2200 of a hydrogen separation apparatus. In it we see the path 2202 followed by the hydrogen as it enters the separation chamber coming from the thermo-magnetic gasification module 2002, which can clearly be seen in the side view 2302 of the hydrogen separator system 2200. Once the gas flow goes through the module 2302, it is comprised of a mixture 2304 of the various gases in air, as well as a mixture of the separated hydrogen and oxygen atoms. The components shown may be made of metal, plastics, composites (such as carbon), fiberglass or others. The airflow 2306 goes into a chamber (in one embodiment shaped as a dome, although other shapes are possible) having one or more membranes 2310 sized so that the oxygen and other massive atoms will continue back into the system 1700. Various levels of insulation may be applied to all external surfaces in order to keep the energy within said system.

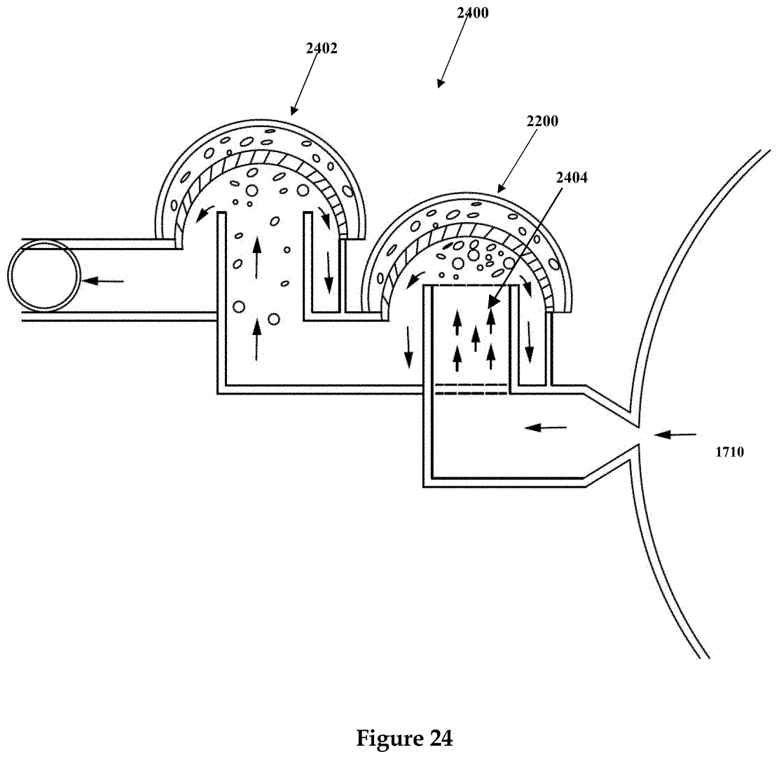

The hydrogen atoms go through said membrane 2310, and cross into a sub-chamber 2308 containing hydrogen atoms in the great majority. From here, said hydrogen may be pumped and stored 2314. As seen in FIG. 24, more 2400 than one hydrogen separation stage 2200 and 2402 may be connected in cascade to ensure maximum hydrogen capture from the system.

In one embodiment, the separation of the hydrogen from the oxygen may be assisted or even completely accomplished by subjecting the magnetically separated Hydrogen/Oxygen atoms to a sudden temperature change, at one or more consecutive locations (say at point 2404). Such a thermal shock, would make the heavier oxygen atoms sink, while the hydrogen atoms raise, potentially making the job of the membrane 2310 easier, simpler to mfr. or even altogether avoiding such a membrane by the utilization of pneumatic ladders which separate the airflow vertically through the creation of a boundary layer flow.

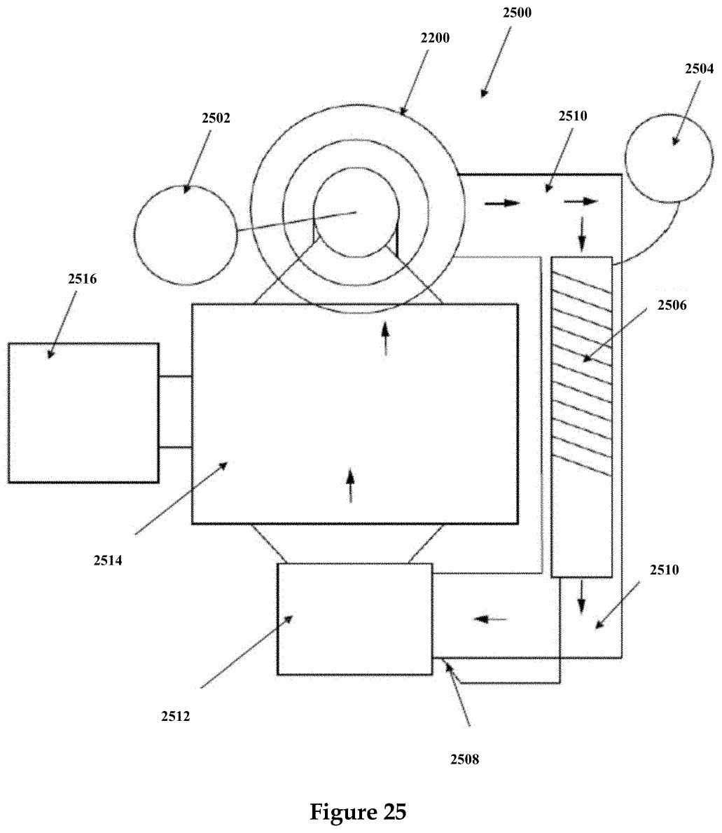

An improved system may be seen in the embodiment 2500 shown in FIG. 25, having a hydrogen separator 2200, connected to a hydrogen storage tank 2502. A water tank 2504 feeds water to a heat exchanger 2506, in order to raise said water's temperature before adding said water 2508 to the gas or airflow 2510. The gas within the system 2500 is moved along the chambers via an air movement module 2512 (blower, fan, turbine or similar) into the thermo-magnetic and gasification module 2514 (either electronic, electromagnetic and/or a Berdut system 600), powered by one or more motors 2516.

In one embodiment, the hydrogen and the oxygen are both collected, leaving the gas “carrier” in a state of humidity depletion. In an alternate embodiment, only the hydrogen is harvested/collected, leaving the oxygen rich gas mixture available for other functions, or to be recirculated. Alternatively, only the oxygen may be harvested. The harvested hydrogen is stored within a container, so that it may transferred, compressed or otherwise handled/stored.

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

1. An induced magnetic field oxyhydrogen generator apparatus comprising;
a hollow cylinder with magnetic field generating components placed around said cylinder concentric longitudinal axis;
one or more orbital pipes located inside said hollow cylinder, so that each said orbital pipe is capable of rotating along said hollow cylinder's concentric longitudinal axis, with each said orbital pipe having at least one metal portion directly exposable to the magnetic field generated by said hollow cylinder magnetic field generating components, wherein one or more of said orbital pipes is freely rotatable about said pipe's concentric axis of rotation, wherein said axis of rotation is parallel to and offset from the longitudinal axis of said magnetic cylinder, and located inside the inner surface of said hollow magnetic cylinder so that any rotation of each said orbital pipe is due solely to the effect of the magnetic field induced on said orbital pipe by said magnetic cylinder rotation;
a mechanism for rotating said magnetic cylinder around the magnetic cylinder's longitudinal axis;
one or more pipes for input of moist gas into said generator; and
one or more pipes for directing all or portions of said generator's oxyhydrogen exhaust.

2. The apparatus of claim 1 wherein;
said magnetic field generating components are comprised of alternating N-pol and S-pol permanent magnets.

3. The apparatus of claim 2 wherein;
said orbital pipes are comprised of ferrous metals.

4. The apparatus of claim 2 wherein;
said orbital pipes are comprised of non-ferrous metals.

5. The apparatus of claim 2 wherein;
said orbital pipes are comprised of a combination of ferrous and non-ferrous metals.

6. An induced magnetic field oxyhydrogen generator system comprising;
a series of conduits connecting one or more chambers;
one or more said chambers containing gas heating components;
one or more said chambers containing gas moving components;
one or more said chambers containing moisture creating components;
one or more said chambers contain a magnetic field oxyhydrogen generator apparatus comprising;
a hollow cylinder with magnetic field generating components placed around said cylinder concentric longitudinal axis;
one or more orbital pipes located inside said hollow cylinder, so that each said orbital pipe is capable of rotating along said hollow cylinder's concentric longitudinal axis, with each said orbital pipe having at least one metal portion directly exposable to the magnetic field generated by said hollow cylinder magnetic field generating components, wherein one or more of said orbital pipes is freely rotatable about said pipe's concentric axis of rotation, wherein said axis of rotation is parallel to and offset from the longitudinal axis of said magnetic cylinder, and located inside the inner surface of said hollow magnetic cylinder so that any rotation of each said orbital pipe is due solely to the effect of the magnetic field induced on said orbital pipe by said magnetic cylinder rotation; and
an outlet pipe taking all or a portion of said magnetic field generator output oxyhydrogen and diverting it outside the system.

7. The apparatus of claim 7 wherein;
said magnetic field generating components are comprised of alternating N-pol and S-pol permanent magnets.

8. The apparatus of claim 7 wherein;
said orbital pipes are comprised of ferrous metals.

9. The apparatus of claim 7 wherein;
said orbital pipes are comprised of non-ferrous metals.

10. The apparatus of claim 7 wherein;
said orbital pipes are comprised of a combination of ferrous and non-ferrous metals.

11. The apparatus of claim 6 wherein:
one or more said chambers containing product drying components;
wherein said product drying components; are comprised of a drying tumbler assembly comprised of solid wall insulated housing having within it a rotating tumbler made from a mesh material and having porous walls, said rotating tumbler having one or more angled blades having a scoop shape that avoids right angles at any point, each blade having a curved blended base with no sharp angles at the blade base to said rotating tumbler, forming a constant radius curve shaped blade base on both sides of said blade base so that each blade lifts and drops portions of product within said tumbler to create a product cascade past an airflow stream going horizontally from an entry opening located on a side of said solid wall insulated housing to an exit opening located on an opposite side in said tumbler assembly's solid walls, both said openings being connected to portions of said series of conduits, said solid walls also having one or more venting openings at said walls' top, for venting of portions of said airflow stream out of said series of conduits and into the atmosphere;
said gas moving components are comprised of a fan.

12. The apparatus of claim 11 wherein;
said magnetic field generating components are comprised of alternating N-pol and S-pol permanent magnets.

13. The apparatus of claim 12 wherein;
said orbital pipes are comprised of ferrous metals.

14. The apparatus of claim 12 wherein;
said orbital pipes are comprised of non-ferrous metals.

15. The apparatus of claim 12 wherein;
said orbital pipes are comprised of a combination of ferrous and non-ferrous metals.
